(19) United States
(12) Patent Application Publication
(10) Pub. No.: US 2025/0153271 A1
(43) Pub. Date: May 15, 2025

(54) LASER WELDING MONITORING APPARATUS

(71) Applicant: Panasonic Intellectual Property Management Co., Ltd., Osaka (JP)

(72) Inventors: IZURU NAKAI, Osaka (JP); KAZUKI FUJIWARA, Osaka (JP); KOJI FUNAMI, Kyoto (JP); TATSURO SHIRAISHI, Osaka (JP)

(21) Appl. No.: 19/021,458

(22) Filed: Jan. 15, 2025

Related U.S. Application Data
(63) Continuation of application No. PCT/JP2023/026312, filed on Jul. 18, 2023.

(30) Foreign Application Priority Data
Jul. 28, 2022 (JP) 2022-120862

(51) Int. Cl. B23K 26/03; B23K 26/082

(52) U.S. Cl. CPC B23K 26/032; B23K 26/082

(57) ABSTRACT

A laser welding monitoring apparatus includes an acquisition interface that acquires a signal corresponding to measurement light measured by irradiating a workpiece with laser light, an arithmetic circuit that determines the state of processing based on the acquired signal, and a storage device that stores in advance variation tendency information corresponding to a tendency of intensity of the measurement light to vary depending on a position of a processing point in a region scannable with the laser light by using an optical system including a galvanometer mirror and a scan lens on the workpiece. When scanning is performed with the laser light by the optical system in a predetermined welding pattern, and the acquisition interface acquires an intensity signal indicating intensity of the measurement light that has been received, the arithmetic circuit corrects the intensity signal and suppresses a variation in intensity depending on a position of the processing point based on the variation tendency information for each light and determines the state of processing based on the intensity signal that has been corrected.

### TECHNICAL FIELD

The present disclosure relates to a laser welding monitoring apparatus that monitors a state of processing with laser welding.

### BACKGROUND ART

As a conventional laser welding monitoring apparatus, for example, PTL 1 discloses a laser welding monitoring apparatus capable of accurately detecting a timing at which a laser welding machine has started welding a material to be welded and starting monitoring of laser welding.

In the laser welding monitoring apparatus of PTL 1, when a laser beam emitted from a processing head is hitting a material to be welded (a butting surface of a sheet metal), a light receiving unit receives radiation light including reflected light of the laser beam and monitoring light formed by heat radiation which is light having a wavelength different from that of the reflected light. A spectroscopic unit spectrally disperses the reflected light and the monitoring light included in the radiation light, and converts the monitoring light into a first electric signal. A trigger unit converts the reflected light into a second electric signal and outputs a trigger signal when a level of the second electric signal is more than or equal to a predetermined threshold value. When the trigger signal is input, a laser welding monitor starts determination whether laser welding on the material to be welded is normally performed based on the first electric signal.

### CITATION LIST

### Patent Literature

PTL 1: Unexamined Japanese Patent Publication No. 2021-137867
PTL 2: Japanese Patent No. 5671873

### SUMMARY OF THE INVENTION

To two-dimensionally move laser light at high speed when laser welding is performed, it is common to use an optical system including a galvanometer scanner (also referred to as a galvano scanner) including a galvanometer mirror, a scan lens (also referred to as an f lens), and the like. As a technique of monitoring a processing point where welding is performed on a workpiece by such a laser welding machine through irradiation with laser light, there is a technique of determining a state of processing by receiving light generated at the processing point as in, for example, PTL 1.

However, in the conventional configuration described in PTL 1, there is a light receiving unit outside an optical system for processing that performs laser irradiation, such as a galvano scanner and an fθ lens. In such a configuration, there is a problem that light from a region wider than the processing point is received, the state of the processing point is hardly reflected on the received light accurately, and the accuracy of determining the state of processing using a signal of the received light may deteriorate.

On the other hand, in the conventional laser welding monitoring apparatus described in PTL 2, a sensor portion such as a photodiode is designed to receive light passing through an optical system for processing. For example, when an optical system including a scanning lens and a galvanometer mirror for performing scanning with laser light is used in such a configuration, an angle, a position, and the like of the laser light entering the scanning lens are changed by scanning with the galvanometer mirror. Thus, there is a problem that the light from the processing point generated through the irradiation with the laser light is dispersed in the scanning lens, and the signal intensity of the light that can be received changes depending on the position of the processing point.

To solve the above conventional problems, an object of the present invention is to provide a laser welding monitoring apparatus capable of accurately monitoring a state of processing with laser welding even when a position of a processing point is changed by an optical system including a scanning lens and a galvanometer mirror.

A laser welding monitoring apparatus according to one aspect of the present disclosure is a laser welding monitoring apparatus that monitors a state of processing with laser welding. The laser welding monitoring apparatus includes an acquisition interface, an arithmetic circuit, and a storage device. The acquisition interface acquires a signal corresponding to measurement light measured by irradiating a workpiece with laser light. The arithmetic circuit performs arithmetic processing of determining the state of processing based on the signal acquired by the acquisition interface. The storage device stores in advance variation tendency information corresponding to a tendency of intensity of the measurement light to vary depending on a position of a processing point in a region scannable with the laser light by using an optical system including a galvanometer mirror and a scan lens on the workpiece. The measurement light includes plasma light generated at the processing point through irradiation with the laser light, heat radiation light, and reflected light of the laser light. The measurement light is received through the optical system when scanning is performed with the laser light by the optical system in a predetermined welding pattern, and is spectrally dispersed into the plasma light, the heat radiation light, and the reflected light. The acquisition interface acquires an intensity signal indicating intensity of each of the plasma light, the heat radiation light, and the reflected light after the measurement light is spectrally dispersed. The arithmetic circuit corrects the intensity signal and suppresses a variation in intensity depending on a position of the processing point based on the variation tendency information for each of the plasma light, the heat radiation light, and the reflected light, and determines the state of processing based on the intensity signal that has been corrected.

The laser welding monitoring apparatus of the present disclosure corrects the signal corresponding to the intensity of the measurement light to suppress the variation in the intensity of the measurement light depending on the position of the processing point. This can suppress the influence on the intensity of the measurement light from the position of the processing point, and for example, a state of processing such as the welding state of the processing point can be accurately monitored based on the corrected signal of the measurement light.

### BRIEF DESCRIPTION OF THE DRAWINGS

FIG. 1 is a schematic diagram of a processing system according to a first exemplary embodiment of the present disclosure.

FIG. 2 is a diagram illustrating a configuration of a monitoring apparatus in the processing system of the first exemplary embodiment.

FIG. 3 is a schematic diagram of a trajectory of welding in the first exemplary embodiment observed from an upper surface of a workpiece.

FIG. 4 is a flowchart illustrating an operation of the monitoring apparatus in the first exemplary embodiment.

FIG. 5 is a diagram for describing waveform data indicating a signal before correction in the monitoring apparatus of the first exemplary embodiment.

FIG. 6 is a flowchart illustrating signal preprocessing in the monitoring apparatus of the first exemplary embodiment.

FIG. 7 is a flowchart illustrating correction processing for each processing position in the monitoring apparatus according to the first exemplary embodiment.

FIG. 8 is a diagram for describing changes in waveform data before and after correction in the first exemplary embodiment.

FIG. 9 is a diagram for describing waveform data after correction in the monitoring apparatus of the first exemplary embodiment.

FIG. 10 is a flowchart illustrating correction table creation processing in the monitoring apparatus of the first exemplary embodiment.

FIG. 11 is a diagram illustrating correction coefficients of waveform data in the first exemplary embodiment.

### DESCRIPTION OF EMBODIMENT

### Aspects of the Present Disclosure

A laser welding monitoring apparatus according to a first aspect of the present disclosure is a laser welding monitoring apparatus that monitors a state of processing with laser welding, including an acquisition interface that acquires a signal corresponding to measurement light measured by irradiating a workpiece with laser light, an arithmetic circuit that performs arithmetic processing of determining the state of processing based on the signal acquired by the acquisition interface, and a storage device that stores in advance variation tendency information corresponding to a tendency of intensity of the measurement light to vary depending on a position of a processing point in a region scannable with the laser light by using an optical system including a galvanometer mirror and a scan lens on the workpiece. The measurement light includes plasma light generated at the processing point through irradiation with the laser light, heat radiation light, and reflected light of the laser light. When the measurement light is received through the optical system when scanning is performed with the laser light by the optical system in a predetermined welding pattern, and is spectrally dispersed into the plasma light, the heat radiation light, and the reflected light, the acquisition interface acquires an intensity signal indicating intensity of each of the plasma light, the heat radiation light, and the reflected light, and the arithmetic circuit corrects the intensity signal and suppresses a variation in intensity depending on a position of the processing point based on the variation tendency information for each of the plasma light, the heat radiation light, and the reflected light, and determines the state of processing based on the intensity signal that has been corrected.

According to a second aspect of the present disclosure, in the laser welding monitoring apparatus according to the first aspect, the predetermined welding pattern includes a plurality of times of welding in which processing conditions are matched except for the position of the processing point, and the variation tendency information is generated based on a plurality of the intensity signals for each of the plasma light, the heat radiation light, and the reflected light of the measurement light from each of a plurality of welding trajectories formed by the plurality of welding.

According to a third aspect of the present disclosure, in the laser welding monitoring apparatus according to the second aspect, the intensity signal that has been corrected has an in-trajectory average that coincides with an inter-trajectory average obtained by averaging in-trajectory averages calculated from respective intensities of the plurality of intensity signals within a predetermined period.

According to a fourth aspect of the present disclosure, in the laser welding monitoring apparatus according to the second or third aspect, an approximate line approximating a temporal change of the intensity signal that has been corrected has a same gradient as an average value obtained by averaging gradients of respective approximate lines of the plurality of intensity signals.

According to a fifth aspect of the present disclosure, in the laser welding monitoring apparatus according to the second or third aspect, an approximate line approximating a temporal change of the intensity signal that has been corrected has a same gradient as a gradient of an approximate line approximating a temporal change of intensity of a laser output that oscillates the laser light.

According to a sixth aspect of the present disclosure, in the laser welding monitoring apparatus according to any one of the first to third aspect, when a parameter including fluence of the laser light changes during welding, an approximate line approximating a temporal change of the intensity signal that has been corrected has a same gradient as a gradient determined according to a change in the fluence.

According to a seventh aspect of the present disclosure, in the laser welding monitoring apparatus according to any one of the second to sixth aspect, the variation tendency information includes, for each of the plurality of welding trajectories, a coefficient for correcting the intensity signal corresponding to the welding trajectory.

According to an eighth aspect of the present disclosure, in the laser welding monitoring apparatus according to any one of the second to seventh aspect, the arithmetic circuit generates the variation tendency information based on the plurality of intensity signals obtained through reception of the measurement light from each of the welding trajectories and stores the variation tendency information in the storage device in advance.

### First Exemplary Embodiment

In a first exemplary embodiment, as an example of using the laser welding monitoring apparatus of the present disclosure, a processing system that performs welding processing with laser light and determines the state of the processing.

### 1. Configuration

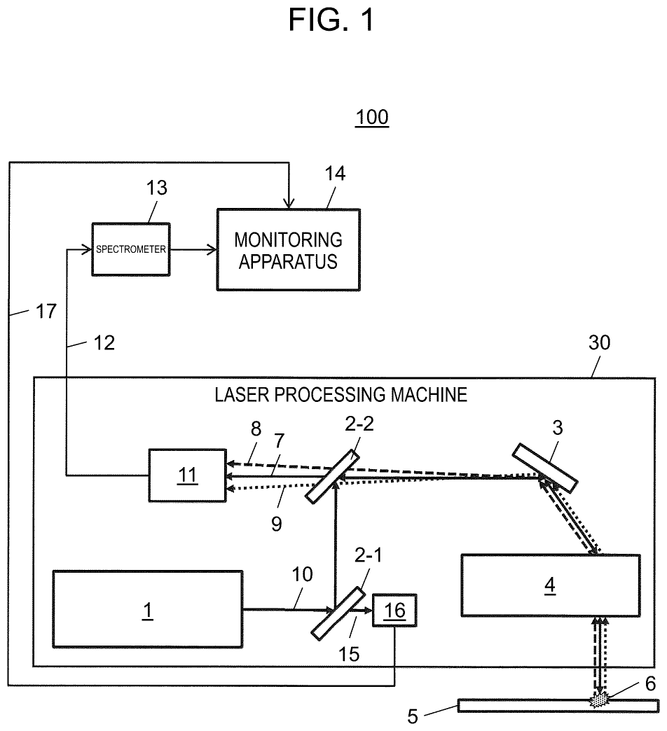

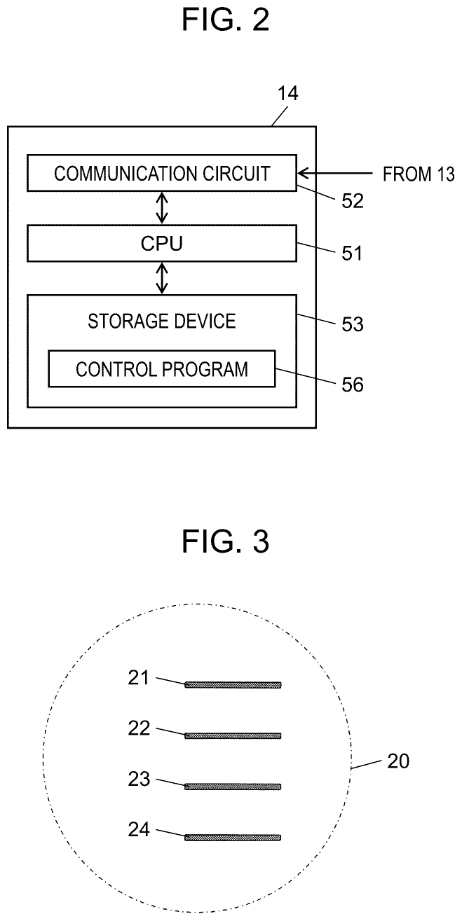

A configuration of a processing system according to the first exemplary embodiment will be described below with reference to FIGS. 1 and 2.

### 1-1. [Configuration of Processing System]

FIG. 1 is a schematic diagram of processing system 100 according to the present exemplary embodiment. Processing system 100 includes laser processing machine 30 that performs laser welding processing through irradiation with laser light, spectrometer 13 that detects and spectrally disperses light from processing point 6 irradiated with the laser light, and monitoring apparatus 14 that monitors a state of processing with laser welding using detected light. The object to be processed by processing system 100, that is, the workpiece, is for example, workpiece 5 made of metal.

In processing system 100 of the present exemplary embodiment, as illustrated in FIG. 1 for example, laser processing machine 30 includes laser oscillator 1, two fixed mirrors 2-1 and 2-2, galvanometer mirror 3, scan lens 4, condensing collimator 11, and photodetector 16.

Laser oscillator 1 supplies light for generating laser light 10 in a pulsed manner, for example. Laser oscillator 1 supplies light having a wavelength of 1070 nm, for example. The wavelength of laser light 10 is not limited to this, and the wavelength may be 532 nm, 450 nm, or the like. Laser light 10 from laser oscillator 1 is reflected by, for example, fixed mirrors 2-1 and 2-2 and enters galvanometer mirror 3. At this time, photodetector 16 detects leakage light 15 of laser light 10 transmitted through mirror 2-1 and generates an electric signal indicating the intensity of the detected light.

Galvanometer mirror 3 includes, for example, two mirrors that are rotatable about axes orthogonal to each other, and a drive unit that rotates each mirror at a predetermined angle. For example, galvanometer mirror 3 can perform two-dimensional scanning with laser light 10 by changing the angle of each mirror to displace processing point 6 irradiated with laser light 10 on workpiece 5. Laser light 10 reflected by galvanometer mirror 3 enters scan lens 4.

Scan lens 4 includes, for example, a plurality of lenses, and is configured such that laser light 10 is perpendicular to the imaging plane regardless of the angle of incidence. Scan lens 4 can converge laser light 10 to have a substantially constant spot diameter when the plane on workpiece 5 is scanned with laser light 10 in a region scannable with galvanometer mirror 3.

When laser light 10 emitted from laser processing machine 30 hits processing point 6 on workpiece 5, laser welding is performed on workpiece 5. At this time, at processing point 6, plasma light as metal-specific light emission that is a visible light component and heat radiation light in the near-infrared region due to temperature rise are mainly generated. In addition, a part of laser light 10 that does not contribute to processing is reflected as return light from processing point 6. In this manner, reflected light, plasma light, and heat radiation light are generated at processing point 6 through irradiation with laser light 10.

For example, as illustrated in FIG. 1, the light generated at processing point 6 passes through scan lens 4 of laser processing machine 30, is reflected by galvanometer mirror 3, and partially enters condensing collimator 11 after passing through mirror 2-2. Condensing collimator 11 includes a condensing lens and condenses reflected light 7, plasma light 8, and heat radiation light 9 that have entered the condensing collimator. The light condensed by condensing collimator 11 is transmitted to spectrometer 13 by optical fiber 12 connecting laser processing machine 30 and spectrometer 13.

Spectrometer 13 spectrally disperses the transmitted light into reflected light 7, plasma light 8, and heat radiation light 9 according to the wavelength. Spectrometer 13 includes, for example, three photodetectors respectively having high sensitivity to different wavelengths, and detects reflected light 7, plasma light 8, and heat radiation light 9 by using each photodetector to generate an electric signal corresponding to the intensity of each detected light. For example, the photodetectors respectively detect reflected light 7 having the same wavelength as the wavelength of laser light 10, plasma light 8 having a visible wavelength (for example, 400 nm to 700 nm), and heat radiation light 9 having an infrared wavelength (for example, 1300 nm). Not limited to the above example, spectrometer 13 may include one photodetector capable of detecting intensity for each wavelength.

Spectrometer 13 further includes, for example, an A/D converter, a CPU, and a communication circuit, converts the electric signal from the photodetector into a digital signal (also simply referred to as “signal”), and transmits the digital signal to monitoring apparatus 14. Monitoring apparatus 14 can measure the intensities of reflected light 7, plasma light 8, and heat radiation light 9 corresponding to the respective signals, for example, by the received signals. In the present disclosure, reflected light 7, plasma light 8, and heat radiation light 9 from processing point 6 measured in this manner are also collectively referred to as “measurement light”.

Upon receiving the signal from spectrometer 13, monitoring apparatus 14 determines the state of processing at processing point 6 based on the signal and outputs a determination result. The configuration of monitoring apparatus 14 and the operation of determining the state of processing will be described later.

The electric signal generated by photodetector 16 corresponding to leakage light 15 of laser light 10 is converted into a digital signal by, for example, the A/D converter included in photodetector 16, and is input to monitoring apparatus 14 through a signal line or the like as laser output signal 17. Laser output signal 17 indicates a signal corresponding to the output of laser light 10 oscillated from laser oscillator 1, and is used as, for example, a trigger signal for starting recording of the measurement light in monitoring apparatus 14.

The configuration of spectrometer 13 is an example, and the light may be spectrally dispersed by, for example, a dichroic mirror or a combination of filters, or may be spectrally dispersed by a diffraction grating or the like. For example, a plurality of bandpass filters may be used to select a wavelength to be passed.

### 1-2. Configuration of Monitoring Apparatus

FIG. 2 is a block diagram illustrating a configuration of monitoring apparatus 14 in processing system 100. Monitoring apparatus 14 is configured as, for example, an information processing apparatus such as a computer. Monitoring apparatus 14 includes central processing unit (CPU) 51 that performs arithmetic processing, communication circuit 52 for communicating with other devices, and storage device 53 that stores data and a computer program.

CPU 51 is an example of an arithmetic circuit in monitoring apparatus 14 of the present exemplary embodiment. CPU 51 executes, for example, control program 56 stored in storage device 53 to implement predetermined functions including determination of a state of processing in monitoring apparatus 14 and signal preprocessing to be described later.

The arithmetic circuit configured as CPU 51 in the present exemplary embodiment may be implemented by processors of various kinds such as an MPU and a GPU, or may be configured by one or a plurality of processors. The arithmetic circuit may be a hardware circuit such as a dedicated electronic circuit or a reconfigurable electronic circuit designed to implement the above-described functions, or may be various semiconductor integrated circuits such as a GPGPU, a TPU, a DSP, a microcomputer, an FPGA, and an ASIC.

Communication circuit 52 is a circuit that performs communication in compliance with a standard such as IEEE802.11, 4G, or 5G, for example. Communication circuit 52 is connectable to a communication network such as the Internet. Communication circuit 52 may perform wired communication in accordance with a standard such as Ethernet (registered trademark). Monitoring apparatus 14 may directly communicate with another device via communication circuit 52, or may communicate via an access point. Monitoring apparatus 14 of the present exemplary embodiment receives a signal from spectrometer 13 through communication circuit 52. Communication circuit 52 may be able to communicate with another device without a communication network, and may include, for example, a connection terminal such as a USB (registered trademark) terminal and/or an HDMI (registered trademark) terminal.

Storage device 53 is a storage medium that stores computer programs and data necessary for implementing the functions of monitoring apparatus 14, and stores, for example, various data such as control program 56 executed by CPU 51 and a signal received from spectrometer 13.

Storage device 53 is configured as, for example, a magnetic storage device such as a hard disk drive (HDD), an optical storage device such as an optical disk drive, or a semiconductor storage device such as a solid state drive (SSD). Storage device 53 may include a temporary storage element configured by a RAM such as a DRAM or an SRAM, or may function as an internal memory of CPU 51.

### 2. Operation

The operation of processing system 100 in the present exemplary embodiment configured as described above will be described below.

### 2-1. Welding Operation

In processing system 100 illustrated in FIG. 1, scanning of workpiece 5 with a condensing point of laser light 10 is performed by the optical system of laser processing machine 30 including galvanometer mirror 3 and scan lens 4, and for example, linear welding is performed. An operation in which processing system 100 of the present exemplary embodiment performs welding to form a welding trajectory, which is a welding mark on a line, on workpiece 5 will be described with reference to FIG. 3.

FIG. 3 is a schematic diagram of a welding trajectory in the present exemplary embodiment observed from the upper surface (that is, the surface of workpiece 5 on laser processing machine 30 side) of workpiece 5. In FIG. 3, four welding trajectories 21 to 24 are formed in region 20 scannable with laser light 10 by the optical system of laser processing machine 30. Processing system 100 performs welding to form each of trajectories 21 to 24 for each pulse by repeatedly emitting, for example, laser light 10 in a pulsed manner. In processing system 100 of the present exemplary embodiment, the optical system of laser processing machine 30 performs scanning with laser light 10 in a predetermined welding pattern forming a plurality of welding trajectories 21 to 24 as illustrated in FIG. 3, for example.

Processing system 100 performs welding under the same welding condition except for the position of processing point 6 corresponding to the irradiation position irradiated with laser light 10 on workpiece 5, that is, the processing position, between welding trajectories 21 to 24 in FIG. 3. The welding conditions can be set in laser processing machine 30 as various parameters such as laser output, welding speed, and focal length.

Although four welding trajectories 21 to 24 are illustrated in FIG. 3, the number of welding trajectories is not limited to four, and may be, for example, two, three, or five or more. The trajectory of welding may be formed at any position within region 20.

### 2-2. Operation of Monitoring Apparatus

The operation of monitoring apparatus 14 that monitors the state of processing in processing system 100 that performs welding with a predetermined welding pattern as described above will be described below.

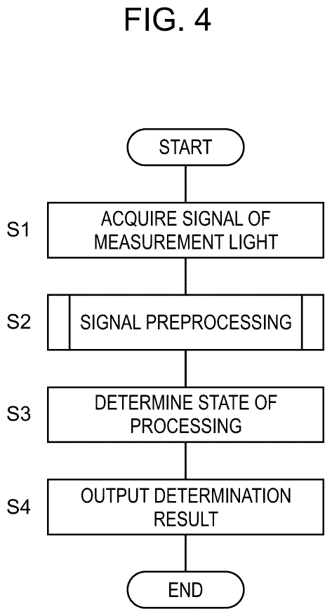

FIG. 4 is a flowchart illustrating an operation of monitoring apparatus 14 in the present exemplary embodiment. The processing illustrated in this flowchart is executed at a predetermined time interval, for example, from the start of processing with a predetermined welding pattern on workpiece 5 to the start of processing on next workpiece 5, and each processing is executed by CPU 51 of monitoring apparatus 14.

First, CPU 51 causes communication circuit 52 to acquire a signal of measurement light detected by spectrometer 13 (S1). For example, CPU 51 acquires signals corresponding to reflected light 7, plasma light 8, and heat radiation light 9, respectively, with the reception of laser output signal 17 input from photodetector 16 of laser processing machine 30 as a trigger. In monitoring apparatus 14 of the present exemplary embodiment, each signal is taken in, for example, as a numerical string corresponding to waveform data indicating a temporal change in strength of the signal (hereinafter, also referred to as “signal intensity”), and is held in an internal memory or the like of CPU 51.

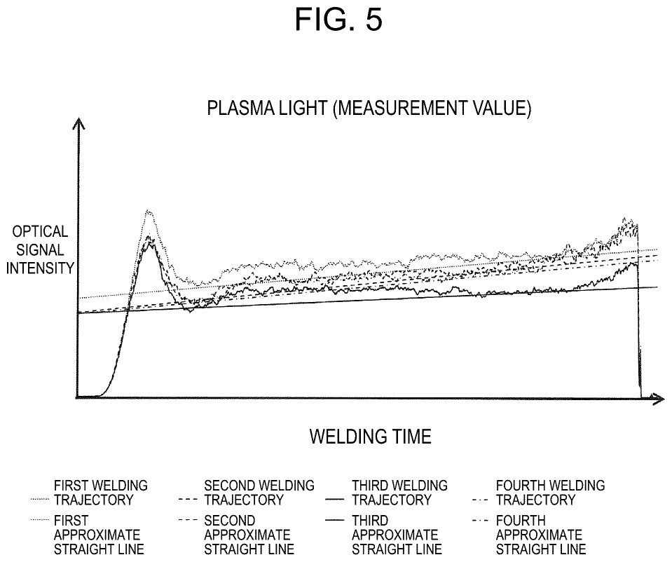

Next, CPU 51 performs preprocessing on each acquired signal (S2). CPU 51 applies preprocessing such as correction for each processing position to be described later to each signal of the measurement light, for example. FIG. 5 is a diagram for describing waveform data indicating a signal before preprocessing, that is, before correction (hereinafter, the data is also referred to as “uncorrected waveform data”). In FIG. 5, the vertical axis represents the signal intensity (also referred to as “optical signal intensity”) corresponding to the intensity of the measurement light, and the horizontal axis represents the welding time, which is the time for performing welding.

FIG. 5 illustrates uncorrected waveform data of plasma light 8 acquired at the time of welding in a welding pattern forming welding trajectories 21 to 24 as illustrated in FIG. 3, for example. In FIG. 5, with the reception of the trigger signal for each pulse corresponding to each of welding trajectories 21 to 24 as the welding time “0”, signal waveforms in the welding periods of the respective trajectories 21 to 24 are superimposed, and are indicated by different line types as “first welding trajectory”, “second welding trajectory”, “third welding trajectory”, and “fourth welding trajectory”. In FIG. 5, approximate straight lines obtained by linearly approximating signal waveforms corresponding to the respective welding trajectories 21 to 24 are indicated by the same line types as the respective signal waveforms as “first approximate straight line”, “second approximate straight line”, “third approximate straight line”, and “fourth approximate straight line”, respectively.

As illustrated in FIG. 5, in the uncorrected waveform data, the gradient of the signal intensity and the signal waveform, that is, the gradient of the approximate straight line varies for each of welding trajectories 21 to 24, that is, for each processing position in region 20 scannable with laser light 10 on workpiece 5. When the processing position varies because of the scanning with laser light 10, in scan lens 4 included in the optical system of laser processing machine 30 illustrated in FIG. 1, for example, the light that is generated and returns from processing point 6 is dispersed and emitted while deviating from the optical axis, and enters condensing collimator 11 with an angle. Thus, the intensity of the measurement light transmitted to monitoring apparatus 14 via optical fiber 12 varies depending on the processing position, and thus, for example, as illustrated in FIG. 5, the signal intensity changes with time in a different tendency for each processing position.

If the state of processing is determined using the uncorrected waveform data of the signal varying for each processing position as described above, a change in signal intensity due to an abnormality during welding is unlikely to appear in the signal, and there is a concern that it is difficult to accurately determine the state of processing, for example. Thus, in monitoring apparatus 14 of the present exemplary embodiment, before the state of processing is determined, preprocessing such as correction for suppressing variation for each processing position is performed on the acquired signal (S2). Details of the signal preprocessing (S2) will be described later.

Description returns to FIG. 4. CPU 51 performs arithmetic processing (S3) of determining the state of processing of processing point 6 with laser welding based on the signal of the measurement light after the preprocessing (S2). CPU 51 determines whether the welding quality at processing point 6 is good or bad as the state of processing by, for example, comparing the intensity of each signal of reflected light 7, plasma light 8, heat radiation light 9 with a predetermined threshold value.

After determining the state of processing (S3), CPU 51 outputs a determination result through communication circuit 52, for example (S4). The determination result can be received and displayed by, for example, an external apparatus or the like capable of data communication with monitoring apparatus 14. Alternatively, monitoring apparatus 14 may include a display apparatus such as a display communicably connected to CPU 51 and cause the display apparatus to display the determination result. CPU 51 may also notify laser processing machine 30 of the determination result via, for example, a signal line connecting monitoring apparatus 14 and laser processing machine 30.

After outputting the determination result (S4), CPU 51 stores, for example, waveform data (S2) indicating the signal after the preprocessing and the determination result (S3) of the state of processing in storage device 53, and ends the processing of this flowchart.

According to the above processing, monitoring apparatus 14 acquires the signal of the measurement light from spectrometer 13 (S1), performs preprocessing on the signal (S2), and determines the state of processing based on the preprocessed signal (S3). This makes it possible to accurately determine the state of processing from the signal corrected by the preprocessing, for example.

The processing of determining the state of processing (S3) is not limited to the above example, and may be performed, for example, based on a signal of a part of the measurement light. The state of processing may be determined by, for example, inputting a signal of the measurement light to a learned model learned to estimate whether the welding quality is good or bad based on the signal strength through various machine learning and causing the learned model to output an estimation result.

### 2-2-1. Signal Preprocessing

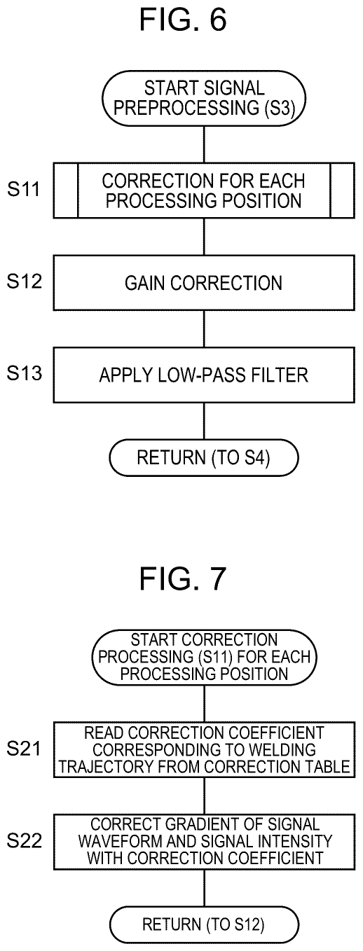

Details of step S2 in FIG. 4 will be described with reference to FIG. 6. FIG. 6 is a flowchart illustrating the signal preprocessing (S2) in monitoring apparatus 14 of the present exemplary embodiment.

The flowchart illustrated in FIG. 6 starts in a state where, for example, the acquired signal (S1) of the measurement light is held in the internal memory or the like of CPU 51 in monitoring apparatus 14. The processing of this flowchart is executed for each of reflected light 7, plasma light 8, and heat radiation light 9 in the measurement light, for example.

First, CPU 51 performs processing of correcting the signal of the measurement light according to the processing position (S11). In the correction processing for each processing position (S11), CPU 51 corrects the signal in the corresponding period for each of welding trajectories 21 to 24 in the welding pattern as illustrated in FIG. 3 based on the acquired signal. Details of the correction processing (S11) for each processing position will be described later.

Next, CPU 51 performs gain correction for correcting the signal intensity so as to absorb variations in the signal intensity due to individual differences of spectrometer 13, for example (S12). CPU 51 also applies a low-pass filter to reduce noise included in the signal, for example (S13). Thereafter, CPU 51 ends the processing of this flowchart and returns to step S3 in FIG. 5.

According to the above processing, various kinds of preprocessing including correction for each processing position (S11) is applied to the signal of the measurement light (S11 to S13). This makes it possible to accurately determine the state of processing using the preprocessed signal (S3). The execution order of steps S11 to S13 is not limited to the example of FIG. 6, and may be executed in an order different from that of FIG. 6.

### 2-2-2. Correction for Each Processing Position

Details of step S11 in FIG. 7 will be described with reference to FIGS. 7 to 9.

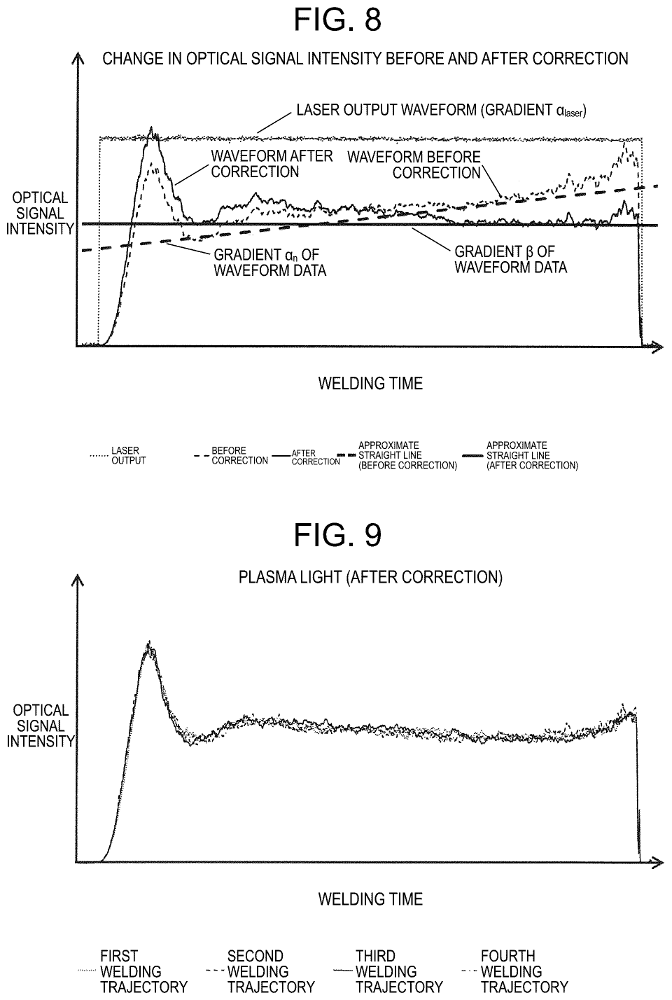

FIG. 7 is a flowchart illustrating correction processing (S11) for each processing position in monitoring apparatus 14 of the present exemplary embodiment. FIG. 8 is a diagram for describing changes in waveform data before and after correction in the present exemplary embodiment. FIG. 9 is a diagram for describing waveform data after correction in monitoring apparatus 14 of the present exemplary embodiment.

In monitoring apparatus 14 of the present exemplary embodiment, for example, as described later, a correction table storing a correction coefficient for correcting a signal is created from a processing position on workpiece 5 and a measurement result of measurement light at the processing position in a welding pattern equivalent to that at the time of determining the state of processing in advance. The created correction table is stored in, for example, storage device 53.

In the flowchart of FIG. 7, first, CPU 51 reads, for example, a correction coefficient corresponding to each of welding trajectories 21 to 24 of FIG. 3 from the correction table created in advance (S21).

For example, for each of welding trajectories 21 to 24, CPU 51 corrects the acquired signal by calculating to multiply the signal in the corresponding period in the signal acquired in step S1 of FIG. 4 by the read correction coefficient (S22). For example, CPU 51 converts the waveform data of the signal to correct the gradient of the signal waveform and the signal strength.

FIG. 8 illustrates signal waveforms before and after correction of a signal corresponding to one trajectory of welding trajectories 21 to 24 with the same vertical axis and horizontal axis as those in FIG. 5. In FIG. 8, the signal waveform before correction is indicated by a broken line, and the signal waveform after correction is indicated by a solid line. In FIG. 8, approximate straight lines obtained by linearly approximating the signal waveforms before and after correction are indicated by broken lines and solid lines, respectively. Further, in FIG. 8, the waveform of the laser output signal is indicated by a dotted line.

With respect to the signal waveform of each of welding trajectories 21 to 24 according to the acquired signal, CPU 51 converts the waveform data from gradient an of the approximate straight line before correction using a correction coefficient corresponding to the same welding trajectory as that before correction such that the gradient of the approximate straight line after correction becomes predetermined gradient β, and outputs the converted waveform data (S22). CPU 51 converts the waveform data by, for example, using the correction coefficient such that the in-trajectory average indicating the average signal intensity based on the waveform data of each of welding trajectories 21 to 24 becomes equal to inter-trajectory average I_{average} indicating the average signal intensity among all welding trajectories 21 to 24 (S22). The in-trajectory average and inter-trajectory average I_{average} will be described later in detail.

In step S22, CPU 51 corrects the gradient of the signal waveform and the signal intensity by multiplying, for example, each sampling position of the waveform data corresponding to each of welding trajectories 21 to 24 by a correction coefficient calculated in advance as described later. The sampling position indicates, for example, a sampling time based on the welding time “0” in the waveform data corresponding to each of welding trajectories 21 to 24. Such multiplication of the correction coefficient makes it possible to obtain, for example, as illustrated in FIG. 8, waveform data after correction in which the gradient of the signal waveform is changed from that before correction.

According to the above processing, the correction coefficient corresponding to each of welding trajectories 21 to 24 is read from the correction table created in advance (S21), and the gradient of the signal waveform and the signal intensity corresponding to the measurement light from each of welding trajectories 21 to 24 are corrected by the correction coefficient (S22). For example, in the present exemplary embodiment, correction is performed such that the gradient of the approximate straight line of each signal waveform becomes a predetermined gradient β, and such that the in-trajectory average of the signal intensity of each signal waveform coincides with inter-trajectory average I_{average}.

FIG. 9 illustrates a signal waveform after correction corresponding to each of welding trajectories 21 to 24 as in FIG. 6. In the example of FIG. 9, from before the correction illustrated in FIG. 5, the average value of the signal intensity for each of welding trajectories 21 to 24 is corrected to be the same as inter-trajectory average I_{average}, and waveform data indicating the signal of the measurement light from welding trajectories 21 to 24 at different processing positions have substantially the same profile. Such correction processing (S11 and S21 to S22) for each processing position makes it possible to suppress variation in signal intensity due to the change in processing position by obtaining the same signal intensity according to the welding time even when the processing position changes such as between welding trajectories 21 to 24, for example.

### 2-3. Correction Table Creation Processing

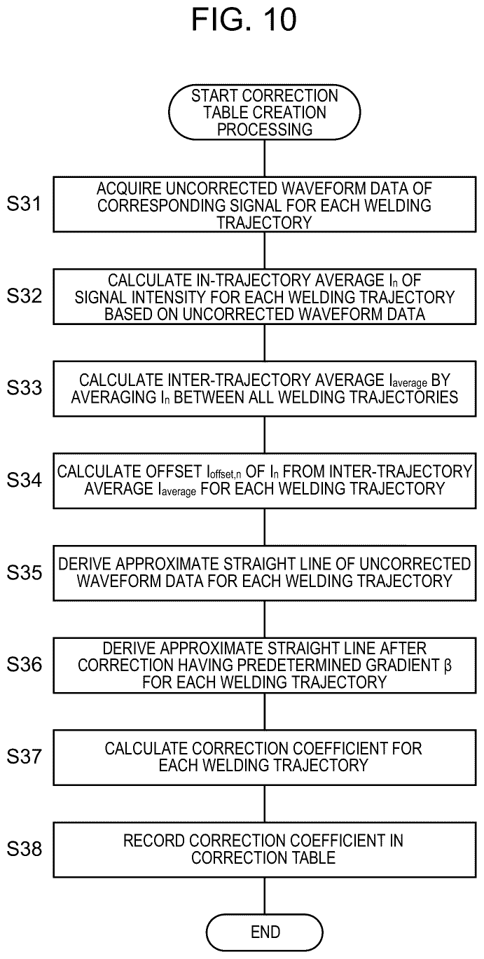

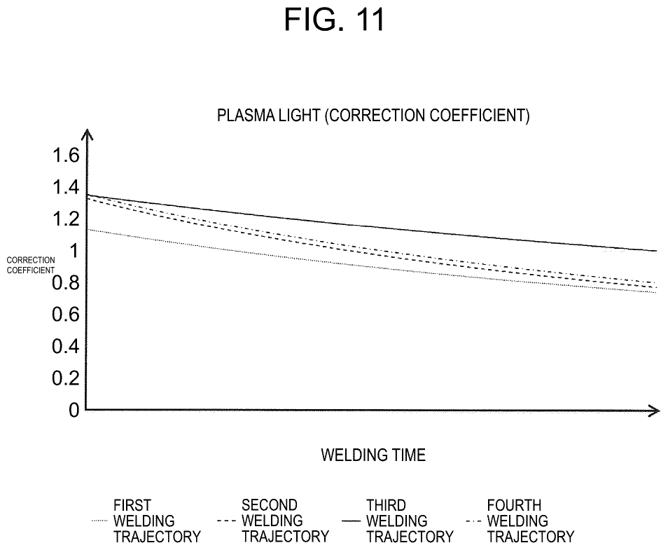

The processing of creating in advance the correction table used in the correction processing (S11) for each processing position as described above will be described with reference to FIGS. 10 and 11.

FIG. 10 is a flowchart illustrating correction table creation processing in monitoring apparatus 14 of the present exemplary embodiment. The processing shown in the flowchart in FIG. 10 is executed by CPU 51 in monitoring apparatus 14, for example, before the processing shown in FIG. 4 is executed. FIG. 11 is a diagram illustrating correction coefficients of waveform data in the present exemplary embodiment.

In the flowchart of FIG. 10, CPU 51 first acquires uncorrected waveform data indicating the signal of the measurement light for each of welding trajectories 21 to 24 at the processing position equivalent to that at the time of determining the state of processing, for example (S31). For example, CPU 51 acquires a signal for each of welding trajectories 21 to 24 for each of reflected light 7, plasma light 8, and heat radiation light 9 (S31), and performs the processing in and after step S32. For example, with respect to plasma light 8, in step S31, the same uncorrected waveform data as in FIG. 5 is acquired.

In step S31, CPU 51 may acquire uncorrected waveform data obtained through welding performed a plurality of times for each of welding trajectories 21 to 24, and may calculate average waveform data obtained by averaging the waveform data obtained a plurality of times, for example. In this case, in the subsequent processing, the average waveform data is used as the acquired uncorrected waveform data.

Next, CPU 51 calculates in-trajectory average Iₙ from the signal intensity in a predetermined period for each of welding trajectories 21 to 24 based on the signal value of the uncorrected waveform data, for example (S32). In-trajectory average Iₙ indicates, for example, a time average of an integral value of signal intensity in a predetermined period for a signal corresponding to each of welding trajectories 21 to 24. Here, the subscript n of Iₙ is a number indicating any of welding trajectories 21 to 24 (for example, n=1, 2, 3, and 4). The predetermined period is set to a period in which the signal intensity exceeds a 0 value in the uncorrected waveform data for each of welding trajectories 21 to 24 corresponding to one pulse of the laser output, for example.

In step S32, CPU 51 calculates in-trajectory average Iₙ of the signal intensity for each of welding trajectories 21 to 24 by, for example, the following calculation formula.

Iₙ=(integral value of signal intensity of uncorrected waveform data of n-th welding trajectory)÷(welding time of entire waveform data of n-th welding trajectory−welding time when laser output of n-th welding trajectory is 0)

After calculating in-trajectory average Iₙ for each of welding trajectories 21 to 24, CPU 51 calculates inter-trajectory average I_{average} indicating an average of in-trajectory average Iₙ among all welding trajectories 21 to 24 (S33). CPU 51 calculates inter-trajectory average I_{average} by using, for example, the following calculation formula. In the example of FIG. 3, number of welding trajectories N is 4.

Inter-trajectory average I_{average} of all welding trajectory=Σ(in-average trajectory Iₙ for each welding trajectory)÷number of welding trajectories N

CPU 51 calculates offset I_{offset,n} between in-trajectory average Iₙ for each of welding trajectories 21 to 24 and inter-trajectory average I_{average} for all welding trajectories 21 to 24 (S34). CPU 51 calculates each offset I_{offset,n} by using the following formula. Each offset I_{offset,n} is used as a correction coefficient so that the average strength in the waveform data after correction corresponding to the n-th welding trajectory coincides with the inter-trajectory of all welding trajectories 21 to 24 in the correction processing for each processing position (S11).

$${I}_{offset , n} = {I}_{average} - {I}_{n}$$

Next, CPU 51 performs linear approximation based on the uncorrected waveform data for each of welding trajectories 21 to 24 to derive an approximation straight line of the signal waveform (S35). Specifically, CPU 51 calculates gradient αₙ and intercept aₙ of the approximate straight line for each of welding trajectories 21 to 24. The approximate straight line is expressed by the following linear approximation formula.

Uncorrected linear approximation formula yₙ(x)=αₙ*x+aₙ

Here, yₙ(x) is the signal intensity on the uncorrected approximate straight line for each welding trajectory, and x is the sampling position of the signal waveform.

In monitoring apparatus 14 of the present exemplary embodiment, the waveform data is a digital signal sampled at regular time intervals, and is expressed as (welding time=sampling interval×sampling position). Since the sampling interval is constant, in the following processing with monitoring apparatus 14, the integer sampling position x is used for calculation instead of the welding time.

Further, for example, in the same uncorrected waveform data as in FIG. 5, the signal intensity in the period corresponding to up to the first 15% and the last 5% of the welding time of the entire waveform data has a larger change amount than the other periods. Thus, in the present exemplary embodiment, for example, only the waveform data of the middle stage corresponding to 15% to 95% with a relatively small change amount in the welding time of the entire waveform data may be used for the calculation of gradient αₙ excluding the start and end with a large change amount.

After deriving the approximate straight line before correction (S35), CPU 51 calculates intercept bₙ in a case where the approximate straight line of the waveform data after correction has predetermined gradient β by, for example, the following linear approximation formula for each of welding trajectories 21 to 24 to derive the approximate straight line after correction (S36).

Corrected linear approximation formula yₙ(x)′=β*x+bₙ+I_{offset,n}

Here, yₙ(x)′ is the signal intensity on the approximate straight line after correction for each welding trajectory, and bₙ is the intercept when the gradient of the approximate straight line is converted into gradient β after correction in a state where in-trajectory average Iₙ is maintained for each of welding trajectories 21 to 24.

In the derivation of the approximate straight line after correction (S36), CPU 51 calculates intercept bₙ of the approximate straight line after correction by using, for example, the following calculation formula.

$${b}_{n} = {I}_{n} - \{ β / {α}_{n} * ( {I}_{n} - {a}_{n} ) \}$$

For predetermined gradient β in the approximate straight line after correction, for example, α_{average} obtained by averaging gradient αₙ of the approximate curve before correction calculated for each of welding trajectories 21 to 24 for all welding trajectories 21 to 24 is used so that the signal intensity has the same temporal change tendency regardless of the processing position.

Based on the derived approximate straight lines (S35, S36) before and after correction, CPU 51 calculates correction coefficient γₙ(x) for converting the uncorrected waveform data into waveform data after correction for each of welding trajectories 21 to 24 as in the following formula (S37).

$${γ}_{n} ( x ) = {y}_{n} ( x ) ’ / {y}_{n} ( x )$$

FIG. 11 exemplifies correction coefficient γₙ(x) calculated for plasma light 8 with welding trajectories 21 to 24 in FIG. 3 as the first to fourth welding trajectories. In FIG. 11, the vertical axis represents correction coefficient γₙ(x), and the horizontal axis represents the welding time corresponding to the sampling position. FIG. 11 illustrates a graph in which correction coefficient γₙ(x) calculated for each sampling position that is discrete time is interpolated. When correction coefficient γₙ(x) is 1, the signal intensity of the measurement light is not changed in the correction processing for each processing position (S11), and when the correction coefficient is a value other than 1, the signal intensity of the measurement light is corrected to a value multiplied by the correction coefficient.

After calculating correction coefficient γₙ(x) (S37), CPU 51 creates a correction table, records correction coefficient γₙ(x), and stores the table in storage device 53 (S38). Thereafter, CPU 51 ends the processing of the flowchart of FIG. 10.

According to the above processing, correction coefficient γₙ(x) for correcting the uncorrected waveform data for each of welding trajectories 21 to 24 is calculated such that welding trajectories 21 to 24 have the same inter-trajectory average I_{average} and each approximate straight line has predetermined gradient β (S31 to S37). Then, a correction table in which correction coefficient γₙ(x) is recorded is created (S38). In the correction processing for each processing position (S11), the signal of the measurement light is corrected so as to suppress variation in the intensity of the measurement light due to the processing position using the correction table created in advance as described above, and the waveform data after correction as illustrated in FIG. 9 can be obtained.

Predetermined gradient β in the approximate straight line after correction is not limited to α_{average} described above, and for example, gradient αₗₐₛₑᵣ in the period of 15% to 95% of the welding time may be calculated and used in the same manner as in the calculation of gradient αₙ before correction in step S35 based on the same waveform data indicating a laser output signal as in FIG. 8. The waveform data of the laser output signal is, for example, a monitored value obtained by detecting, by photodetector 16, a laser output given as a parameter of the welding condition at the time of creating the correction table in laser processing machine 30. The period corresponding to 15% to 95% of the welding time of the entire waveform data corresponds to, for example, a period in which the laser output is in a steady state.

### 3. Effects

Monitoring apparatus 14 of the present exemplary embodiment is an example of a laser welding monitoring apparatus that monitors a state of processing with laser welding, as described above. Monitoring apparatus 14 includes communication circuit 52 that is an example of an acquisition interface, CPU 51 that is an example of an arithmetic circuit, and storage device 53. Communication circuit 52 acquires a signal corresponding to measurement light measured through irradiation of workpiece 5 (an example of a workpiece) with laser light 10 (S1). CPU 51 performs arithmetic processing of determining a state of processing based on the signal acquired by communication circuit 52 (S2, S3). Storage device 53 stores a correction table in advance as an example of variation tendency information corresponding to a tendency of the intensity of the measurement light to vary depending on the position of processing point 6 in region 20 scannable with laser light 10 on workpiece 5 by using the optical system including galvanometer mirror 3 and scan lens 4, that is, the processing position. The measurement light includes plasma light 8, heat radiation light 9, and reflected light 7 of laser light 10. When scanning with laser light 10 is performed by the optical system in the predetermined welding pattern, the measurement light is received through the optical system and spectrally dispersed into plasma light, heat radiation light, and reflected light. Then, communication circuit 52 acquires a signal indicated by the uncorrected waveform data as an example of the intensity signal indicating the intensity of each of plasma light 8, heat radiation light 9, and reflected light 7 (S1). For each of plasma light 8, heat radiation light 9, and reflected light 7, CPU 51 corrects the acquired signal based on the correction table so as to suppress variation in the intensity depending on the processing position (S2, S11), and determines the state of processing based on the corrected signal (S3).

According to monitoring apparatus 14 described above, even when the signal intensity of the measurement light varies depending on the processing position as scanning is performed with laser light 10 by the optical system including galvanometer mirror 3 and scan lens 4, the variation in the intensity depending on the processing position is corrected (S2, S11). As a result, the signal intensity in which the influence of the varying processing position is suppressed can be obtained, and for example, the state of processing can be accurately determined from the signal intensities of the three types of measurement light to be monitored (S3).

In the present exemplary embodiment, the predetermined welding pattern includes a plurality of times of welding in which processing conditions are matched except for the processing position, and the correction table is created based on a plurality of signals for plasma light 8, heat radiation light 9, and reflected light 7 by the measurement light from each of the plurality of welding trajectories 21 to 24 formed by the plurality of times of welding in region 20 scannable with laser light 10 (S31 to S38). This makes it possible to create the correction table by reflecting the variation in the measurement light depending on the processing position between welding trajectories 21 to 24, for example.

In the present exemplary embodiment, the corrected signal has an inter-trajectory average that coincides with inter-trajectory average I_{average} obtained by averaging in-trajectory average Iₙ calculated from the signal intensity within the predetermined period of each signal in the plurality of signals corresponding to the plurality of welding trajectories 21 to 24 (see S11, S22). This makes it possible to correct the signal such that a change in the state of processing or the like other than the processing position in the laser welding in each of welding trajectories 21 to 24 easily appears in the signal intensity, for example.

In the present exemplary embodiment, the approximate straight line (an example of the approximate line) that approximates the temporal change of the corrected signal has the same gradient as average value α_{average} obtained by averaging the gradients of the approximate straight lines of the intensities of the signals in the plurality of signals corresponding to the plurality of welding trajectories 21 to 24 (see S22, S36). Alternatively, the approximate straight line has the same gradient as gradient αₗₐₛₑᵣ of the approximate straight line that approximates the temporal change in the intensity of the laser output oscillating laser light 10. According to the correction of the gradient, for example, it is possible to suppress variation in the signal intensity in the temporal change due to the processing position for each of welding trajectories 21 to 24.

In the present exemplary embodiment, the correction table includes a correction coefficient as an example of a coefficient for correcting a signal corresponding to each of welding trajectories 21 to 24 for each of the plurality of welding trajectories 21 to 24 (S37, S38). As a result, in the correction processing for each processing position (S11), the signal can be efficiently corrected by a simple calculation of multiplying the acquired signal by the correction coefficient recorded in the correction table in advance, for example (S21 to S22).

In the present exemplary embodiment, CPU 51 creates a correction table based on a plurality of signals obtained by receiving the measurement light from welding trajectories 21 to 24, and stores the correction table in storage device 53 in advance (S31 to S38). Monitoring apparatus 14 may acquire a correction table created by an external arithmetic device or the like in advance and store the correction table in storage device 53 without creating the correction table, for example.

### Other Exemplary Embodiments

The first exemplary embodiment has been described as an example of the technique disclosed in the present application, as described above. The technique according to the present disclosure is, however, not limited to the above exemplary embodiment, and is also applicable to other exemplary embodiments with an appropriate modification, replacement, addition, omission, or the like made thereto. Other exemplary embodiments will be described below as an example.

In the first exemplary embodiment described above, an example has been described in which the waveform data of the signal of the measurement light is corrected for each processing position using a correction coefficient (S36, S37) calculated such that the approximate straight line after correction has constant gradient α_{average} or αₗₐₛₑᵣ regardless of time as predetermined gradient β (S22). In the present exemplary embodiment, as predetermined gradient β, a gradient that changes with time may be used. For example, when the fluence of laser light 10 changes during welding as a parameter of the welding condition, a gradient determined according to the change in fluence may be used. In this case, for example, in step S22 of FIG. 7, CPU 51 may correct the acquired signal so that the approximate straight line for the signal intensity of the signal acquired in step S1 of FIG. 4 has a gradient corresponding to the change in fluence.

In this manner, in the present exemplary embodiment, when the parameter including the fluence of laser light 10 changes during welding, the approximate straight line (an example of the approximate line) approximating the temporal change in the intensity of the corrected signal (an example of the temporal change in the intensity signal) has the same gradient as the gradient determined according to the change in fluence.

In each exemplary embodiment described above, an example has been described in which correction coefficient γₙ(x) for each of the plurality of welding trajectories 21 to 24 is calculated (FIG. 10), and the correction processing for each processing position (FIG. 7) is performed. In the present exemplary embodiment, the correction coefficient is not limited to be obtained for a welding pattern in which a plurality of welding trajectories are formed, but the correction coefficient may be calculated for a welding pattern in which one welding trajectory is formed, and correction for each processing position may be performed using the correction coefficient. For example, in the same processing as in FIG. 10, the correction coefficient may be calculated such that the gradient of the approximate curve after correction becomes gradient αₗₐₛₑᵣ of the laser output waveform in the period in which the laser output is in the steady state without particularly calculating inter-trajectory average I_{average}.

In each exemplary embodiment described above, monitoring apparatus 14 that acquires the signals of reflected light 7, plasma light 8, and heat radiation light 9 has been described. In the present exemplary embodiment, for example, a corresponding signal may be obtained for one or a combination of two of reflected light 7, plasma light 8, and heat radiation light 9.

In each exemplary embodiment described above, an example has been described in which monitoring apparatus 14 acquires a signal from external spectrometer 13. However, it is an example that spectrometer 13 and monitoring apparatus 14 are separate bodies. The laser welding monitoring apparatus of the present disclosure may be an apparatus in which both are integrated. In this case, the acquisition interface in the laser welding monitoring apparatus may be an internal input terminal or connection terminal that receives a signal from a circuit that detects light and generates a signal.

The present disclosure is not limited to the exemplary embodiments described above, and various modifications can be made. That is, exemplary embodiments obtained by combining technical means suitably modified by those skilled in the art also fall within the scope of the present disclosure.

### INDUSTRIAL APPLICABILITY

The laser welding monitoring apparatus of the present disclosure can be applied to a technique for monitoring a state of processing with laser welding in which a workpiece is scanned with laser light based on measurement light from a processing point.

1. A laser welding monitoring apparatus that monitors a state of processing with laser welding, the laser welding monitoring apparatus comprising:
an acquisition interface that acquires a signal corresponding to measurement light measured by irradiating a workpiece with laser light;
an arithmetic circuit that performs arithmetic processing of determining the state of processing based on the signal acquired by the acquisition interface; and
a storage device that stores in advance variation tendency information corresponding to a tendency of intensity of the measurement light to vary depending on a position of a processing point in a region scannable with the laser light by using an optical system including a galvanometer mirror and a scan lens on the workpiece,
wherein the measurement light includes plasma light generated at the processing point through irradiation with the laser light, heat radiation light, and reflected light of the laser light,
the measurement light is received through the optical system when scanning is performed with the laser light by the optical system in a predetermined welding pattern, and is spectrally dispersed into the plasma light, the heat radiation light, and the reflected light,
the acquisition interface acquires an intensity signal indicating intensity of each of the plasma light, the heat radiation light, and the reflected light after the measurement light is spectrally dispersed, and
the arithmetic circuit:
corrects the intensity signal and suppresses a variation in intensity depending on a position of the processing point based on the variation tendency information for each of the plasma light, the heat radiation light, and the reflected light; and
determines the state of processing based on the intensity signal that has been corrected.

2. The laser welding monitoring apparatus according to claim 1,
wherein the predetermined welding pattern includes a plurality of times of welding in which processing conditions are matched except for the position of the processing point,
the plurality of times of welding forms a plurality of welding trajectories in the region scannable on the workpiece, and
the variation tendency information is generated based on a plurality of the intensity signals corresponding to the plurality of welding trajectories for each of the plasma light, the heat radiation light, and the reflected light of the measurement light from each of the plurality of welding trajectories.

3. The laser welding monitoring apparatus according to claim 2,
wherein the intensity signal that has been corrected has an in-trajectory average that coincides with an inter-trajectory average obtained by averaging in-trajectory averages calculated from respective intensities of the plurality of intensity signals within a predetermined period.

4. The laser welding monitoring apparatus according to claim 2,
wherein an approximate line approximating a temporal change of the intensity signal that has been corrected has a same gradient as an average value obtained by averaging gradients of respective approximate lines of the plurality of intensity signals.

5. The laser welding monitoring apparatus according to claim 2,
wherein an approximate line approximating a temporal change of the intensity signal that has been corrected has a same gradient as a gradient of an approximate line approximating a temporal change of intensity of a laser output that oscillates the laser light.

6. The laser welding monitoring apparatus according to claim 1,
wherein when a parameter including fluence of the laser light changes during welding, an approximate line approximating a temporal change of the intensity signal that has been corrected has a same gradient as a gradient determined according to a change in the fluence.

7. The laser welding monitoring apparatus according to claim 2,
wherein the variation tendency information includes, for each of the plurality of welding trajectories, a coefficient for correcting the intensity signal corresponding to the welding trajectory.

8. The laser welding monitoring apparatus according to claim 2,
wherein the arithmetic circuit generates the variation tendency information based on the plurality of intensity signals and stores the variation tendency information in the storage device in advance.
